(19) United States
(12) Patent Application Publication
(10) Pub. No.: US 2024/0272830 A1
(43) Pub. Date: Aug. 15, 2024

(54) STORAGE CONTROLLER, AN OPERATING METHOD OF THE SAME, AND A STORAGE SYSTEM

(71) Applicant: SAMSUNG ELECTRONICS CO., LTD., SUWON-SI (KR)

(72) Inventor: Sangwon Jung, Suwon-si (KR)

(21) Appl. No.: 18/434,913

(22) Filed: Feb. 7, 2024

(30) Foreign Application Priority Data
Feb. 9, 2023 (KR) 10-2023-0017569

(51) Int. Cl. G06F 3/06

(52) U.S. Cl. CPC G06F 3/0659; G06F 3/0611; G06F 3/0658; G06F 3/0679

(57) ABSTRACT

A storage controller including: an internal event monitoring circuit to detect an internal event, the internal event being independently performed in the storage controller; a duration calculation circuit to calculate expected processing times of the internal event based on allocation ratios; a latency mapping table to output expected latencies in processing the internal event for the allocation ratios; and an update circuit to generate and provide multi-latency information to a host, wherein the multi-latency information includes an indicator representing the internal event and the expected processing times and the expected latencies corresponding to the allocation ratios, each allocation ratio representing a ratio of a resource, allocated to process the internal event, to a resource allocated to process a command requested by the host, and the storage controller is configured to allocate resources for processing the command and the internal event, based on an allocation ratio selected by the host.

### CROSS-REFERENCE TO RELATED APPLICATION

This application claims priority under 35 U.S.C. § 119 to Korean Patent Application No. 10-2023-0017569, filed on Feb. 9, 2023, in the Korean Intellectual Property Office, the disclosure of which is incorporated by reference herein in its entirety.

### TECHNICAL FIELD

The inventive concept relates to a memory device, and more particularly, to a storage controller, an operating method thereof, and an operating method of a storage system.

### DISCUSSION OF RELATED ART

Flash memory is a type of non-volatile memory that can retain data stored therein even when power is disconnected. Recently, storage devices that incorporate flash memory, such as an embedded multi-media card (eMMC), a universal flash storage (UFS), a solid state drive (SSD), or a memory card, have become increasingly popular. These devices are useful for storing and transferring large amounts of data.

With the growing need for storage capacity, there's also a demand for storage devices with low latency. However, today's storage devices face a challenge where latency increases due to an internal event that is autonomously performed to extend the device's lifetime, irrespective of a host device. The reduction in performance could be potentially mitigated through distributed processing.

### SUMMARY

The inventive concept provides a storage controller, a storage device, and an operating method of the storage controller, which may provide a host device with information about an expected latency, a type of event, and an expected processing time when an internal event occurs.

According to an embodiment of the inventive concept, there is provided a storage controller including: an internal event monitoring circuit configured to detect that an internal event occurs, wherein the internal event is independently performed in the storage controller; a duration calculation circuit configured to calculate expected processing times of the internal event based on each of a plurality of allocation ratios; a latency mapping table configured to output expected latencies in processing the internal event for each of the plurality of allocation ratios; and an update circuit configured to generate multi-latency information and provide the multi-latency information to a host device, wherein the multi-latency information includes an indicator representing the internal event and the expected processing times and the expected latencies respectively corresponding to the plurality of allocation ratios, each of the plurality of allocation ratios represents a ratio of a resource, allocated to process the internal event, to a resource allocated to process a command requested by the host device, and the storage controller is configured to allocate resources for processing the command and the internal event, based on an allocation ratio selected by the host device from among the plurality of allocation ratios.

According to an embodiment of the inventive concept, there is provided an operating method of a storage controller, the operating method including: detecting an internal event that is capable of being independently performed in the storage controller; calculating expected processing times of the internal event based on each of a plurality of allocation ratios, wherein each of the plurality of allocation ratios represents a ratio of a resource, allocated to process the internal event, to a resource allocated to process a command requested by a host device; calculating expected latencies in processing the internal event based on each of the plurality of allocation ratios; generating multi-latency information respectively corresponding to the plurality of allocation ratios, wherein the multi-latency information includes an indicator representing the internal event and the expected processing times and the expected latencies; providing the multi-latency information to the host device; and receiving a response indicating an allocation ratio, selected by the host device from among the plurality of allocation ratios, from the host device to allocate resources for processing the internal event and the command requested by the host device.

According to an embodiment of the inventive concept, there is provided a storage system including: a storage device including an internal event monitoring circuit configured to detect an occurrence of an internal event that is independently performed in a storage controller, a duration calculation circuit configured to calculate expected processing times of the internal event based on each of a plurality of allocation ratios representing a ratio of a resource, allocated to process the internal event, to a resource allocated to process a command requested by a host device, and an update circuit configured to generate multi-latency information, and provide the multi-latency information to the host device, wherein the multi-latency information includes an indicator representing the internal event and the expected processing times and the expected latencies respectively corresponding to the plurality of allocation ratios; and the host device configured to select an allocation ratio from among the plurality of allocation ratios and provide the storage device with mode information indicating the selected allocation ratio, wherein the storage device is configured to receive the mode information from the host device and allocate each of resources for processing the internal event and the command requested by the host device, based on the allocation ratio indicated by the mode information.

### BRIEF DESCRIPTION OF THE DRAWINGS

Embodiments of the inventive concept will be more clearly understood from the following detailed description taken in conjunction with the accompanying drawings in which:

FIG. 1 is a block diagram illustrating a storage system according to an embodiment;

FIG. 2 is a block diagram illustrating a non-volatile memory according to an embodiment;

FIG. 3 is a circuit diagram illustrating a memory block according to an embodiment;

FIG. 4 is a block diagram illustrating a multi-latency generating circuit according to an embodiment;

FIG. 5 illustrates a signal exchange diagram of a storage system according to an embodiment;

FIG. 6 illustrates an example of multi-latency information according to an embodiment;

FIG. 7 is a flowchart illustrating an operating method of a host device, according to an embodiment;

FIG. 8 illustrates a time-latency graph with respect to an operation mode, according to an embodiment;

FIG. 9 illustrates a percentile-latency graph of a write command with respect to an operation mode, according to an embodiment; and

FIG. 10 illustrates a percentile-latency graph of a read command with respect to an operation mode, according to an embodiment.

### DETAILED DESCRIPTION OF THE EMBODIMENTS

Hereinafter, embodiments of the inventive concept will be described in detail with reference to the accompanying drawings. Like reference indicators in the drawings may refer to like elements.

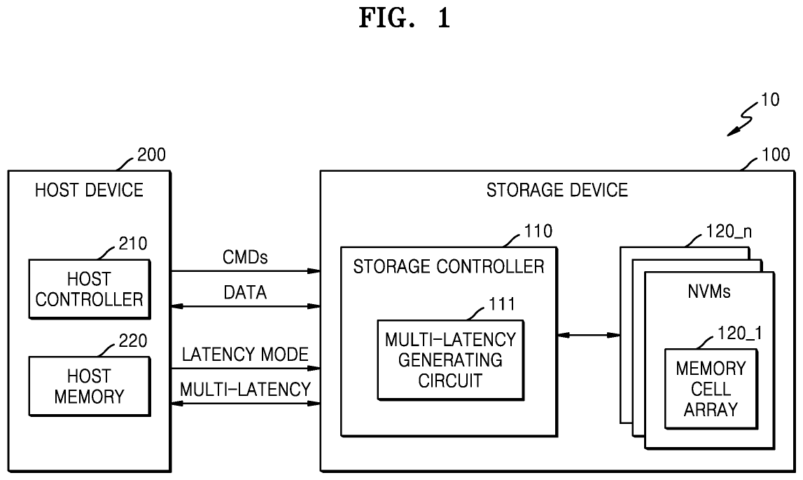

FIG. 1 is a block diagram illustrating a storage system 10 according to an embodiment.

Referring to FIG. 1, the storage system 10 may include a storage device 100 and a host device 200 and may thus be referred as a host-storage system. The storage device 100 may include a storage controller 110 and a non-volatile memory (NVM) 120, and the storage controller 110 may be connected with the non-volatile memory 120 through a channel. The non-volatile memory 120 may be provided in plural as a plurality of non-volatile memories 120_ 1 to 120_n. Each of the non-volatile memories 120_ 1 to 120_n may include a memory cell array 121_ 1 to 121_n.

According to an embodiment, the storage controller 110 may be referred to as a controller, a device controller, or a memory controller. According to an embodiment, the non-volatile memory 120 may be implemented with a plurality memory chips or a plurality of memory dies. For example, each of the plurality of memory chips may be a dual die package (DDP), a quadruple die package (QDP), or an octuple die package (ODP).

According to an embodiment, the host device 200 may include a host controller 210 and a host memory 220. The host memory 220 may function as a buffer memory for temporarily storing write data which is to be transferred to the storage device 100 or read data transferred from the storage device 100. The host controller 210 may be one of a plurality of modules included in an application processor (AP), and the AP may be implemented as a system on chip (SoC). The host memory 220 may be an embedded memory included in the AP, or may be a non-volatile memory or a memory module disposed outside the AP.

According to an embodiment, the host device 200 may transfer a plurality of commands to the storage device 100. For example, the host device 200 may transfer a write command and write data to the storage device 100 to store data therein. As another example, the host device 200 may transfer a read command to the storage device 100 and may receive read data read from the storage device 100 in response to the read command.

According to an embodiment, the storage controller 110 may control the non-volatile memory 120 to write the write data in a memory cell array 121 of the non-volatile memory 120 in response to the write command requested from the host device 200. Additionally, in response to the read command requested from the host device 200, the storage controller 110 may control the non-volatile memory 120 to read data stored in the memory cell array 121 of the non-volatile memory 120 and provide the read data to the host device 200. Therefore, the storage device 100 may include storage mediums for storing data. For example, the storage device 100 may include at least one of a solid state drive (SSD), an embedded memory, and an attachable/detachable external memory. For example, when the storage device 100 is an SSD, the storage device 100 may be a device based on the non-volatile memory express (NVMe) standard. For example, when the storage device 100 is an embedded memory or an external memory, the storage device 100 may be a device based on the universal flash storage (UFS) standard, the embedded multi-media card (eMMC) standard, or the compute express link (CXL) standard. Each of the host device 200 and the storage device 100 may generate a packet based on a standard protocol applied thereto and may transfer the generated packet .

According to an embodiment, the storage controller 110 may further include a multi-latency generating circuit 111. The multi-latency generating circuit 111 may detect an internal event and may generate multi-latency information corresponding to the detected internal event. The internal event may denote an internal operation which is directly performed by the storage device 100 regardless of the host device 200. In other words, the internal event can be an operation executed directly by the storage device 100, independent of any input from the host device 100. For example, the internal event may include a read reclaim, a wear leveling, a garbage collection, a block close, and a bad block detection operation but is not limited thereto. According to various embodiments, the internal event may denote all events including an autonomous write operation and an erase operation of the storage device 100.

According to an embodiment, the storage controller 110 may select one allocation ratio from among a plurality of allocation ratios to operate. For example, the storage controller 110 can choose one allocation ratio from a plurality of allocation ratios for its operation. The allocation ratio may denote a ratio of an internal allocation resource, allocated to perform the detected internal event, to an external allocation resource allocated to perform a request from the host device 200 among resources of the storage controller 110. The external allocation resource may represent the allocation of resources to perform a request of the host device 200 and may be referred to in various terms such as a host allocation resource. The internal allocation resource may represent the allocation of resources to perform an event occurring in the storage device 100 and may be referred to in various terms such as an event allocation resource.

For example, the storage controller 110 may operate in a first operation mode corresponding to a first allocation ratio. The first operation mode may be an operation mode where the storage device 100 preferentially performs the detected internal event. For convenience of description, when an allocation ratio is represented by [external allocation resource:internal allocation resource], the first allocation ratio may be [0:100]. In other words, in the first operation mode, the detected internal event may only be performed.

As another example, the storage controller 110 may operate in a second operation mode corresponding to a second allocation ratio. The second operation mode may be an operation mode where the storage device 100 performs the detected internal event and a request from the host device 200. The second allocation ratio corresponding to the second operation mode may be [50:50]. In other words, in the second operation mode, both the detected internal event and a request from the host device 200 may be performed.

As another example, the storage controller 110 may operate in a third operation mode corresponding to a third allocation ratio. The third operation mode may be an operation mode where the storage device 100 preferentially performs a request from the host device 200. However, because the internal event is detected by the storage device 100, at least resource allocation for processing the internal event may be needed. In this case, the storage controller 110 may allocate a resource of a predetermined ratio (for example, a minimum ratio) to an internal allocation resource for processing the internal event and may allocate all of the other resources as an external allocation resource. The predetermined ratio may be about 5% but is not limited thereto. When the predetermined ratio is about 5%, the third allocation ratio may be [95:5].

The multi-latency information may include a plurality of latencies and a plurality of durations each corresponding to the internal event detected by the storage device 100. The plurality of latencies and the plurality of durations may respectively denote latencies and durations, which are predicted by processing the detected internal event, based on a plurality of allocation ratios. For example, the multi-latency information may include a first latency and a first duration, which are predicted in processing the internal event, based on a first mode of the first allocation ratio. The first mode may denote a mode in which the performance (or resource) of the storage device 100 is maximally used without an input/output to/from the host device 200. For example, the multi-latency information may include a second latency and a second duration, which are predicted in processing the internal event, based on a second mode of the second allocation ratio. The second mode may denote a mode in which half of the available performance of the storage device 100 is allocated to command processing with the host device 200 and the other half of the available performance of the storage device 100 is allocated to an operation of performing the detected internal event. The multi-latency information may include a third latency and a third duration, which are predicted in processing the internal event, based on a third mode of the third allocation ratio. The third mode may denote a mode which allocates only the minimum size of available performance of the storage device 100 to the processing of the detected internal event and allocates the rest of the available performance of the storage device 100 to command processing with the host device 200.

According to an embodiment, the host device 200 may receive the multi-latency information (e.g., MULTI-LATENCY), determine an operation mode of the storage device 100, and respond to the storage device 100 with a latency mode (e.g., LATENCY MODE) indicating the determined operation mode. For example, the host controller 210 of the host device 200 may receive the multi-latency information to identify the first to third latencies. The host controller 210 may receive the multi-latency information to identify the first to third durations. The host device 200 may receive the multi-latency information, and thus, when the storage device 100 operates in each of the first to third operation modes, the host device 200 may previously identify a predicted latency and a predicted processing time of the internal event. In other words, when the storage device 100 operates in any of the first through third operation modes, the host device 200 can pre-identify the expected latency and anticipated processing time for the internal event. The host controller 210 may determine one of the first to third modes based on the number of preprocessed commands (for example, the length of a command queue), requirements for quality of service (QOS), and an input/output bandwidth currently corresponding to the storage device 100. For example, when the requirements for QoS are high, the host controller 210 may determine a mode for minimizing a latency. As another example, when it is predicted that there is no input/output corresponding to the storage device 100, the host controller 210 may determine a mode for minimizing a duration. The multi-latency generating circuit 111 is described below in detail.

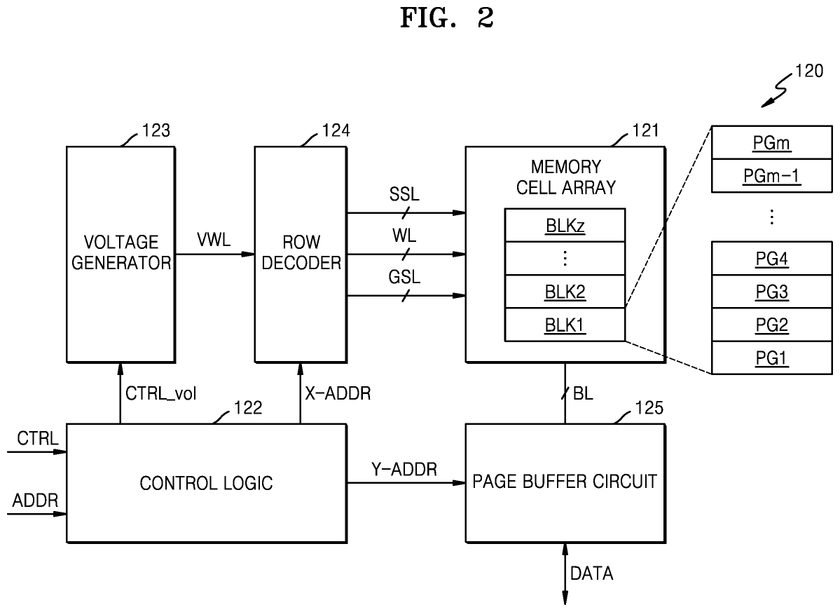

FIG. 2 is a block diagram illustrating a non-volatile memory 120 according to an embodiment.

Referring to FIG. 2, the non-volatile memory 120 may include a memory cell array 121, a control logic circuit 122, a voltage generator 123, a row decoder 124, and a page buffer circuit 125. The non-volatile memory 120 may further include a memory interface circuit, and may further include a column logic, a pre-decoder, a temperature sensor, a command decoder, and an address decoder.

The memory cell array 121 may include a plurality of memory blocks BLK1 to BLKz, and each of the plurality of memory blocks BLK1 to BLKz may include a plurality of pages PG1 to PGm. Here, z and m may each be a positive integer and may be variously changed depending on embodiments. For example, a memory block may be a unit of erasure and a page may be a unit of write and read. The memory cell array 121 may be connected with the page buffer circuit 125 through bit lines BL and may be connected with the row decoder 124 through word lines WL, string selection lines SSL, and ground selection lines GSL.

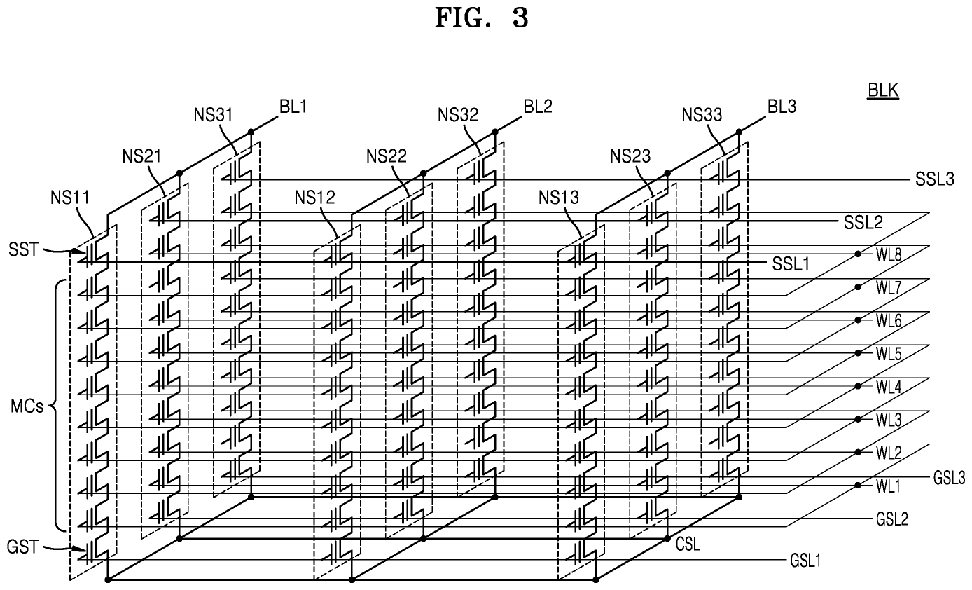

In an embodiment, the memory cell array 121 may include a three-dimensional (3D) memory cell array and the 3D memory cell array may include a plurality of NAND strings. Each of the plurality of NAND strings may include memory cells respectively connected with word lines vertically stacked on a substrate. The plurality of NAND strings may be arranged in a row direction and a column direction. U.S. Pat. Nos. 7,679,133, 8,553,466, 8,654,587 and 8,559,235 and U.S. Patent Application Publication No. 2011/0233648, which describe 3D non-volatile memories, are incorporated by reference herein in their entireties. The 3D memory cell array is described below in more detail with reference to FIG. 3.

In some embodiments, the memory cell array 121 may include various kinds of non-volatile memories, and thus, the non-volatile memory 120 may include magnetic random access memory (RAM) (MRAM), spin-transfer torque MRAM, conductive bridging RAM (CBRAM), ferroelectric RAM (FeRAM), phase change RAM (PRAM), resistive RAM (ReRAM), and other various kinds of memories.

The control logic circuit 122 may control various operations of the non-volatile memory 120. The control logic circuit 122 may output various control signals in response to a command CMD and/or an address ADDR. For example, the control logic circuit 122 may output a voltage control signal CTRL_vol, a row address X_ADDR, and a column address Y_ADDR. The voltage generator 123 may generate various kinds of voltages for performing program, read, and erase operations based on the voltage control signal CTRL_vol. For example, the voltage generator 123 may generate a program voltage, a read voltage, a program verify voltage, and an erase voltage as a word line voltage VWL.

In response to the row address X_ADDR, the row decoder 124 may select one word line WL from among a plurality of word lines WL and may select one string selection line SSL from among a plurality of string selection lines SSL. For example, in a program operation, the row decoder 124 may apply the program voltage and the program verify voltage to the selected word line WL and in a read operation, the row decoder 124 may apply the read voltage to the selected word line WL. The page buffer circuit 125 may select at least one bit line from among the bit lines BL in response to the column address Y_ADDR. The page buffer circuit 125 may operate as a write driver or a sense amplifier depending on an operation mode.

FIG. 3 is a circuit diagram illustrating a memory block BLK according to an embodiment.

Referring to FIG. 3, the memory block BLK may be a NAND flash memory having a vertical structure and may correspond to one of the plurality of memory blocks BLK1 to BLKz of FIG. 2. The memory block BLK may include NAND strings NS11, NS12, NS13, NS21, NS22, NS23, NS31, NS32 and NS33, and each NAND string (for example, NS11) may include a string selection transistor SST, a plurality of memory cells MCs, and a ground selection transistor GST, which are serially connected with one another. The string and ground selection transistors SST and GST and the memory cells MCs each included in each NAND string may configure a structure stacked in a vertical direction on a substrate.

Bit lines BL1, BL2 and BL3 may extend in a first direction and word lines WL1, WL2, WL3, WL4, WL5, WL6, WL7 and WL8 may extend in a second direction. NAND strings NS11 to NS31 may be disposed between the first bit line BL1 and a common source line CSL, NAND strings NS12 to NS32 may be disposed between the second bit line BL2 and the common source line CSL, and NAND strings NS13 to NS33 may be disposed between the third bit line BL3 and the common source line CSL.

The string selection transistor SST may be connected with corresponding string selection lines SSL1, SSL2 and SSL3. The memory cells MCs may be respectively connected with the word lines WL1 to WL8 corresponding thereto. The ground selection transistor GST may be connected with corresponding ground selection lines GSL1, GSL2 and GSL3. The string selection transistor SST may be connected with a corresponding bit line and the ground selection transistor GST may be connected with the common source line CSL. Here, the number of NAND strings, the number of word lines, the number of bit lines, the number of ground selection lines, and the number of string selection lines may be variously changed depending on embodiments.

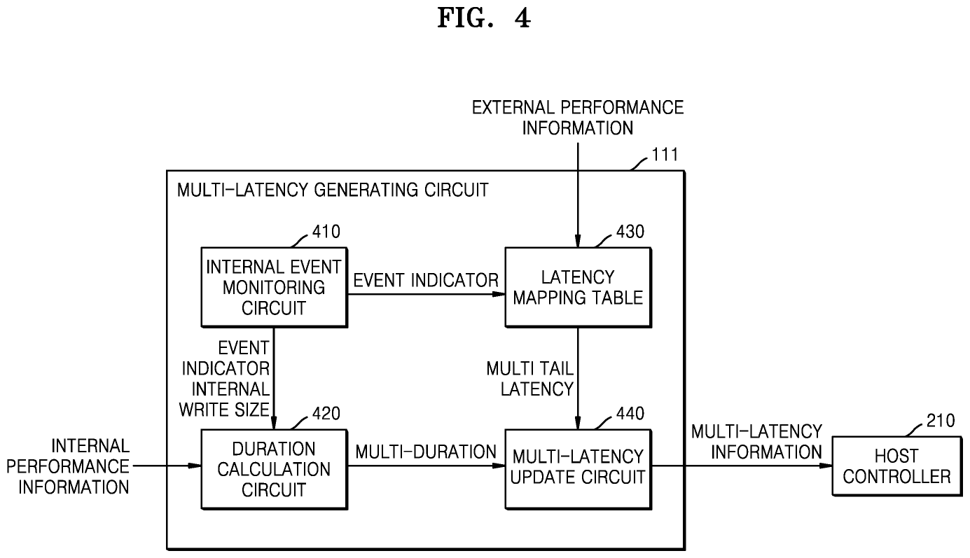

FIG. 4 is a block diagram illustrating a multi-latency generating circuit 111 according to an embodiment.

Referring to FIG. 4, the multi-latency generating circuit 111 may include an internal event monitoring circuit 410, a duration calculation circuit 420, a latency mapping table 430, and a multi-latency update circuit 440. The multi-latency generating circuit 111 of FIG. 4 may correspond to the multi-latency generating circuit 111 included in the storage controller 110 of FIG. 1. As can be seen each component of the multi-latency generating circuit 111 may be implemented in hardware as a circuit, for example.

According to various embodiments, the internal event monitoring circuit 410 may monitor whether an internal event occurs or not. The internal event may denote an event where the storage device 100 performs at least one of a write operation and an erase operation autonomously irrespective of a command from the host device 200. The internal event may occur irrespective of an instruction from the host device 200 and may thus be referred to in various terms such as a self-event and an independent event.

According to an embodiment, the internal event monitoring circuit 410 may be implemented in a flash translation layer (FTL). The FTL may manage a main operation of the storage device 100. For example, the FTL may map a logical page address to a physical page address of the non-volatile memory 120, or may periodically perform garbage collection for securing a free block for writing data.

According to an embodiment, the internal event monitoring circuit 410 may previously store an internal event mapping table. The internal event mapping table may be a table which is previously set between the storage device 100 and the host device 200 and may be a table showing a mapping relationship representing the type of event for each internal event. The internal event mapping table may be shown as the following Table 1.

TABLE 1

| Event Indicator | Type of Internal Event |
|---|---|
| 1 | Read Reclaim |
| 2 | Wear Leveling |
| 3 | Garbage Collection |
| 4 | Block Close |
| 5 | Bad Block Detection |

The host controller 210 may decode an event indicator included in multi-latency information to identify the type of event occurring in the storage device 100.

In response to detecting an internal event, the internal event monitoring circuit 410 may provide the latency mapping table 430 and the duration calculation circuit 420 with an event indicator corresponding to the detected internal event. Additionally, the internal event monitoring circuit 410 may provide the duration calculation circuit 420 with an internal write size. The internal write size may denote the size of a write operation needed to perform the detected internal event. For example, when an internal event of the read reclaim occurs, the internal write size may denote the size of data for copying a block, where distribution sagging occurs due to degradation, to a new block.

According to various embodiments, the duration calculation circuit 420 may calculate the time taken to complete the detected internal event. The duration calculation circuit 420 may receive, from the internal event monitoring circuit 410, information about the internal write size and the event indicator. The duration calculation circuit 420 may further receive internal performance information. The internal performance information may represent performance allocated to an operation of performing the detecting internal event by using the storage device 100. For example, when the read reclaim occurs, the internal performance information may include the size of an internal write for performing the read reclaim.

According to an embodiment, the duration calculation circuit 420 may calculate a duration size by using a function based on the internal write size received from the internal event monitoring circuit 410 and the obtained internal performance information and internal ratio. The internal ratio may represent a ratio of internal performance for processing the internal event to external performance for an input/output to/from the host device 200 among available performances of the storage device 100. For example, when the internal ratio is 100, the storage device 100 may use all of the available performances to process only the internal event. As another example, when the internal ratio is 50, the storage device 100 may allocate half of the available performances to the input/output to/from the host device 200 and may allocate the other half of the available performances to internal event processing of the storage device 100. As another example, when the internal ratio is default, the storage device 100 may allocate only a predefined ratio (for example, 5%) of the available performances to internal event processing of the storage device 100 and may allocate the other available performances to an operation of performing the input/output to/from the host device 200.

According to an embodiment, the duration calculation circuit 420 may output a multi-duration to the multi-latency update circuit 440 based on an internal event occurring therein. The duration calculation circuit 420 may calculate three durations respectively corresponding to three internal ratios based on the internal event occurring therein. For example, when the internal event of the read reclaim occurs, the duration calculation circuit 420 may calculate each duration based on three internal ratios, based on internal performance information and an internal write size of the read reclaim. The duration calculation circuit 420 may allocate all internal performances without the input/output to/from the host device 200 and may thus calculate a first duration, which is the time taken to process the read reclaim, a second duration, which is the time taken to process the read reclaim on only half of the internal performances, and a third duration, which is the time taken to process the read reclaim on only 5% of the internal performances.

According to various embodiments, the latency mapping table 430 may store a plurality of mapping tables. Each of the plurality of mapping tables may store tail latency values based on a write speed and a read speed corresponding to the host device 200 for each internal event. For example, referring to tables in conjunction with Table 1, the latency mapping table 430 may include five sub-tables corresponding thereto for each internal event. Each of the sub-tables may previously store tail latency values based on a read speed and a write speed. For example, each sub-table may be shown as the following Table 2.

TABLE 2
Internal Event: Read Reclaim

| Read Speed | Write Speed | Tail Latency (99.9%) |
|---|---|---|
| 100 MB/s | 100 MB/s | L00 |
| | . . . | . . . |
| | 1000 MB/s | L09 |
| 200 MB/s | 100 MB/s | L10 |
| | . . . | . . . |
| | 1000 MB/s | L19 |

. . .

| | | |
|---|---|---|
| 1000 MB/s | 100 MB/s | L90 |
| | . . . | . . . |
| | 1000 MB/s | L99 |

The latency mapping table 430 may receive external performance information and may output a multi tail latency, based on the external performance information. The latency mapping table 430 may output three latencies respectively corresponding to three internal ratios. For example, when an internal event of the read reclaim occurs, the latency mapping table 430 may output a multi-latency with reference to a sub-table corresponding to the read reclaim. For example, with reference to the external performance information, when an external write speed is about 1,000 MB/s, the latency mapping table 430 may output, to the multi-latency update circuit 440, each of a third latency corresponding to a write speed of about 9,950 MB/s, a second latency corresponding to a write speed of about 500 MB/s, and a first latency corresponding to a write speed of about 50 MB/s.

According to various embodiments, the multi-latency update circuit 440 may generate multi-latency information and may provide the generated multi-latency information to the host controller 210. The multi-latency information may be generated based on all of a multi tail latency received from the latency mapping table 430 and a multi-duration received from the duration calculation circuit 420. In other words, the multi-latency update circuit 440 may generate the multi-latency information including each latency and duration based on internal ratios for processing the detected internal event.

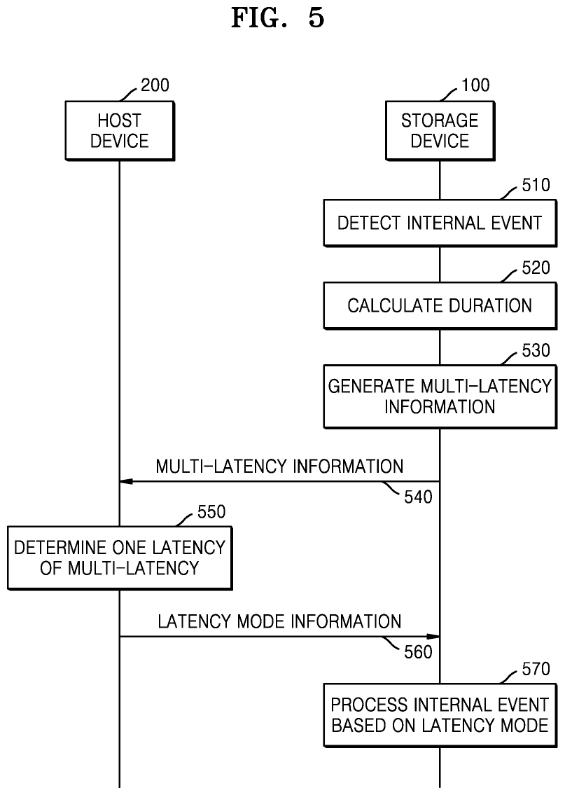

FIG. 5 illustrates a signal exchange diagram of a storage system 10 according to an embodiment.

Referring to FIG. 5, in operation 510, the storage device 100 may detect an internal event. For example, the internal event monitoring circuit 410 of the storage controller 110 may previously detect that at least one event of the read reclaim, the garbage collection, the wear leveling, the bad block detection, and the block close is performed after a certain time elapses.

In operation 520, the storage device 100 may calculate a duration. The storage device 100 may calculate a plurality of durations which differ, based on an internal ratio. For example, the duration calculation circuit 420 of the storage controller 110 may receive an event indicator indicating the internal event which is detected in operation 510 and an internal write size associated with the internal event. Additionally, the duration calculation circuit 420 may receive internal performance information. The internal performance information may represent a write speed for performing the internal event. The duration calculation circuit 420 may calculate a duration, which is the time taken to complete the internal event, based on the internal performance information and the internal write size. In this case, the duration calculation circuit 420 may calculate each of a plurality of durations based on various internal ratios. For example, the duration calculation circuit 420 may calculate a first duration, which is the time taken when all available performances are allocated to process the internal event, a second duration, which is the time taken when half of the available performances are allocated to process the internal event, and a third duration, which is the time taken when a minimum value of the available performances is allocated to process the internal event.

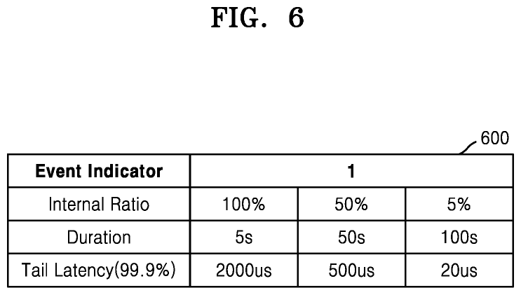

In operation 530, the storage controller 110 may generate multi-latency information and in operation 540, the storage controller 110 may provide the multi-latency information to the host device 200. For example, the storage controller 110 may provide the multi-latency information to the host controller 210. The multi-latency information may be generated based on all of a multi tail latency received from the latency mapping table 430 and a multi-duration received from the duration calculation circuit 420. For example, referring to FIG. 6, the multi-latency information may be shown in a table 600. The multi-latency information may include an event indicator for indicating an internal event. For example, when an internal event of the read reclaim occurs, the event indicator may represent “1” with reference to Table 1. The multi-latency information may represent a latency and a duration each corresponding to three internal ratios. For example, the multi-latency information may include a first duration of when an internal ratio is 100%, a second duration of when an internal ratio is 50%, and a third duration of when an internal ratio is 5%. Additionally, the multi-latency information may include a first latency of when an internal ratio is 100%, a second latency of when an internal ratio is 50%, and a third latency of when an internal ratio is 5%.

In operation 550, the host device 200 may determine one latency of a multi-latency. The host controller 210 may identify a value of a tail latency and a duration taken to complete an internal event by using each internal ratio, based on the multi-latency information. The host controller 210 may determine one latency, based on requirements for QoS and an input/output bandwidth currently corresponding to the storage device 100.

According to an embodiment, when a QoS value is greater than a first threshold value, the host controller 210 may minimize a latency to satisfy the QoS value. To minimize a latency, the host controller 210 may determine a third mode which processes an internal event at an internal ratio of 5%. When the QoS value is less than a second threshold value, which is less than the first threshold value, the host controller 210 may determine a first mode. When the QoS value is less than the second threshold value, the requirements for QoS may be low, and thus, the host controller 210 may select the first mode to process the internal event the fastest rather than minimizing a latency. When the QoS value is less than the first threshold value and greater than the second threshold value, the host controller 210 may determine a second mode.

According to other embodiments, when the length of a command queue is less than a first threshold length, the host controller 210 may determine the first mode. For example, when there is no command waiting or there is a very small number of commands waiting (e.g., when the command queue is small), the host device 200 may predict that there is no input/output to/from the storage device 100 or there is a very small number of inputs/outputs to/from the storage device 100, and thus, the host device 200 may select the first mode and may control the storage device 100 to quickly process the internal event during a period in which there is no input/output or there are a very small number of inputs/outputs. When the length of a command queue is greater than a second threshold length, the host controller 210 may determine the third mode. The host device 200 may determine that there is a very large number of commands currently waiting and may select the third mode to increase the command processing speed.

In operation 560, the host device 200 may provide latency mode information to the storage device 100. The latency mode information may indicate one of the first mode, the second mode, and the third mode. The first mode may be a mode for minimizing a duration and may indicate a mode having an internal ratio of 100% for processing the internal event on all available performances. The second mode may indicate a mode having an internal ratio of 50% for allocating half of available performances to process the internal event and allocating the other half of the available performances to process a command requested by the host device 200. The third mode may be a mode for minimizing a latency and may indicate a mode having an internal ratio of 5% for allocating a minimum value of the available performances to process the internal event and allocating the rest of the available performances to process a command requested by the host device 200. In other words, when the requirements for QoS are high, the host device 200 may provide the storage device 100 with latency mode information indicating the third mode and when there is no command which is to be requested from the storage device 100, the host device 200 may provide the storage device 100 with latency mode information indicating the first mode.

In operation 570, the storage device 100 may process the internal event based on the latency mode. For example, when the latency mode corresponds to the first mode, the storage device 100 may allocate all of the available performances to process the internal event to complete the internal event during the first duration having a short time. However, when the storage device 100 is operating based on the first mode, a tail latency value of a command requested by the host device 200 may be the maximum. As another example, when the latency mode corresponds to the third mode, the storage device 100 may allocate only a minimum value of the available performances to process the internal event and may allocate the rest of the available performances to process the command requested by the host device 200 to operate. In other words, when requirements for QoS of the command requested by the host device 200 are high, because the requirements for QOS may not be satisfied when a tail latency is large, the storage device 100 may allocate a minimum performance to process the internal event. However, because the number of resources allocated to process the internal event is small, the third duration, which is the time taken until the internal event is completed, may be the largest.

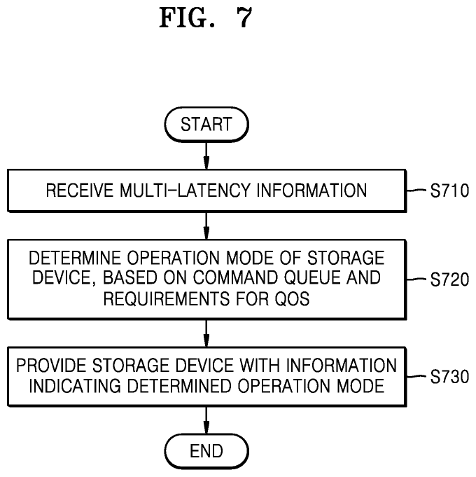

FIG. 7 is a flowchart illustrating an operating method of a host device 200, according to an embodiment.

Referring to FIG. 7, in operation S710, the host device 200 may receive multi-latency information. The multi-latency information may correspond to the table 600 of FIG. 6. For example, the multi-latency information may include a multi-latency, a multi-duration, and an event indicator indicating an internal event detected in the storage device 100. The multi-latency information may include a first duration, which is the time taken until an internal event predicted in operating in a first mode in which all resources are allocated to processing of the internal event is completed, and a first latency, which is a tail latency capable of occurring in operating in the first mode. The multi-latency information may include a second duration, which is the time taken until an internal event predicted in operating in a second mode in which half of all resources are allocated to processing of the internal event is completed, and a second latency, which is a tail latency capable of occurring in operating in the second mode. The multi-latency information may include a third duration, which is the time taken until an internal event predicted in operating in a third mode in which minimum resources are allocated to processing of the internal event is completed, and a third latency, which is a tail latency capable of occurring in operating in the third mode. The third duration may be greater than the second duration and the second duration may be greater than the first duration. The first latency may be greater than the second latency and the second latency may be greater than the third latency.

In operation S720, the host device 200 may determine an operation mode of the storage device 100, based on a host command queue and requirements for QoS. According to an embodiment, when the host command queue is empty, there may be no command which is to be requested by the host controller 210 from the storage device 100. While there is no command which is to be requested from the storage device 100, the storage device 100 quickly processes an internal event. Therefore, when the host command queue is empty or a queue depth (QD) of the host command queue is less than or equal to a threshold size, the host controller 210 may determine the first mode as an operation mode of the storage device 100 to quickly complete the internal event. According to other embodiments, when requirements for QoS are greater than a threshold value, the host controller 210 may determine the third mode as an operation mode of the storage device 100. When a tail latency increases, because the requirements for QoS are not able to be satisfied, the host controller 210 may select the third mode, which allocates most of the available resources to process a command from the host device 200, to minimize a latency. In operation S730, the host controller 210 may provide the storage device 100 with latency mode information indicating the determined operation mode.

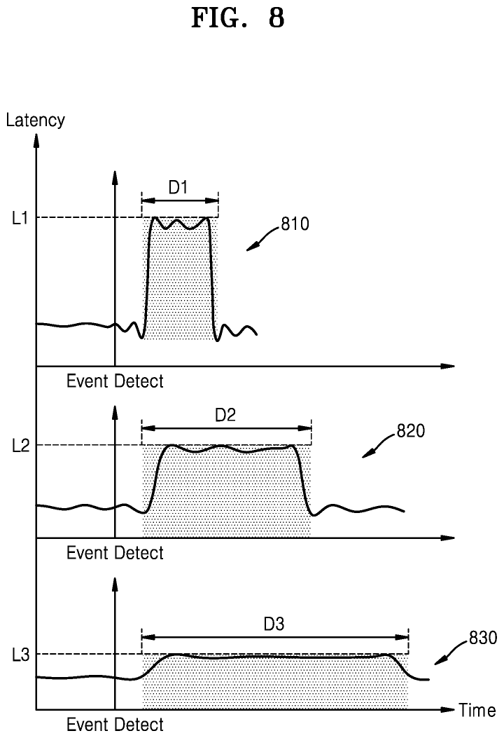

FIG. 8 illustrates a time-latency graph with respect to operation mode, according to an embodiment.

Referring to FIG. 8, a first graph 810 may be a time-latency graph when the storage device 100 operates in a first operation mode. The first operation mode may be a mode for processing the internal event as quick as possible, and all resources of the storage device 100 may be allocated to perform the internal event. Therefore, compared with second and third graphs 820 and 830, it may be seen that a first period D1, which is the time taken until the internal event in the first mode is completed after the start of the internal event, is the shortest. Additionally, latency of the Y axis may represent latency measured with respect to the host device 200. Because all resources of the storage device 100 are allocated to performing the internal event, processing of a command requested by the host device 200 may be considerably delayed. Therefore, compared with the second and third graphs 820 and 830, it can be seen that a maximum value of a first latency L1 is the largest.

The second graph 820 may be a time-latency graph when the storage device 100 operates in a second operation mode. The second operation mode may be an intermediate mode between the first operation mode and a third operation mode, and half of all resources of the storage device 100 may be allocated to performing the internal event and the other half of the resources of the storage device 100 may be allocated to processing a command requested by the host device 200. Compared with the first graph 810, because resources allocated to performing the internal event decrease by half, it can be seen that a second period D2, which is the time taken until the internal event is completed after the start of the internal event, increases compared to the first graph 810. On the other hand, because half of all resources of the storage device 100 are allocated to processing the command requested by the host device 200, a maximum value of a second latency L2 may be less than the maximum value of the first latency L1.

The third graph 830 may be a time-latency graph when the storage device 100 operates in a third operation mode. The third operation mode may be a mode which allocates only a minimum-sized resource of all resources of the storage device 100 to performing the internal event and allocates most resources, except the minimum-sized resource, of all resources to processing the command requested by the host device 200. Compared with the second graph 820, because the size of a resource allocated to processing the internal event is the minimum size, it can be seen that a third period D3, which is the time taken until the internal event is completed after the start of the internal event, is the largest compared to the first graph 810 and the second graph 820. On the other hand, because most of all resources of the storage device 100 are allocated to processing the command requested by the host device 200, a maximum value of a third latency L3 may be less than the maximum value of the second latency L2.

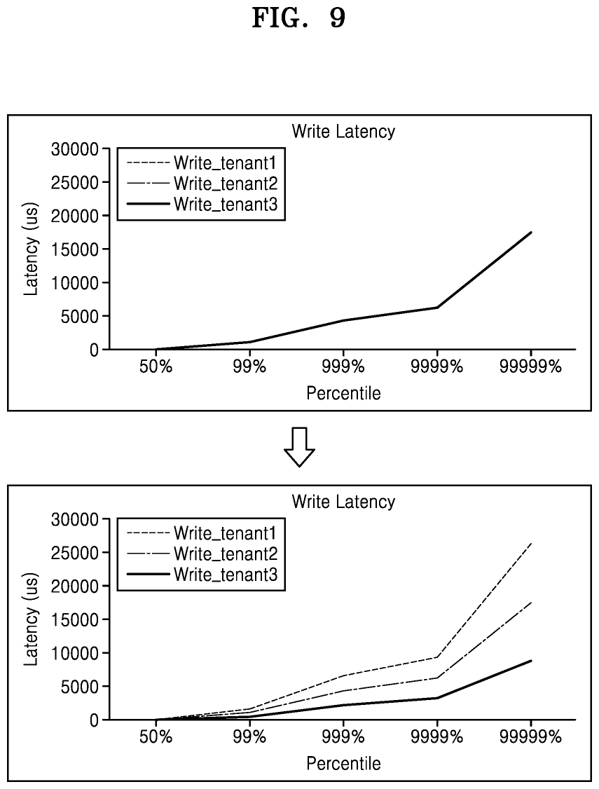

According to an embodiment, referring to FIG. 9, a percentile-latency graph of a write command is shown. It can be seen that percentile-based latencies of a write command of all latencies according to a comparative example (top graph) are equal to one another. In other words, because a storage device according to the comparative example does not provide a host device with duration information and an allocation ratio-based latency of a resource for processing an internal event and the host device does not select a resource allocation ratio, latencies of all tenants may be equal to one another. A first tenant according to an embodiment may be a host device which has selected the first operation mode, a second tenant may be a host device which has selected the second operation mode, and a third tenant may be a host device which has selected the third operation mode. As described above, it can be seen that a tail latency of the first tenant increases rapidly as a percentile increases. Because the first tenant has allocated all resources to an operation of performing the internal event in the first operation mode, a tail latency recognized by the host device may rapidly increase. It can be seen that a tail latency of the third tenant increases in proportion to a percentile, but the size of a latency is reduced compared to the other tenants. Because the third tenant allocates minimum resources to an operation of performing the internal event in the third operation mode and allocates most of all resources to processing of a write command requested by the host device, a tail latency recognized by the host device may be improved compared to the other tenants.

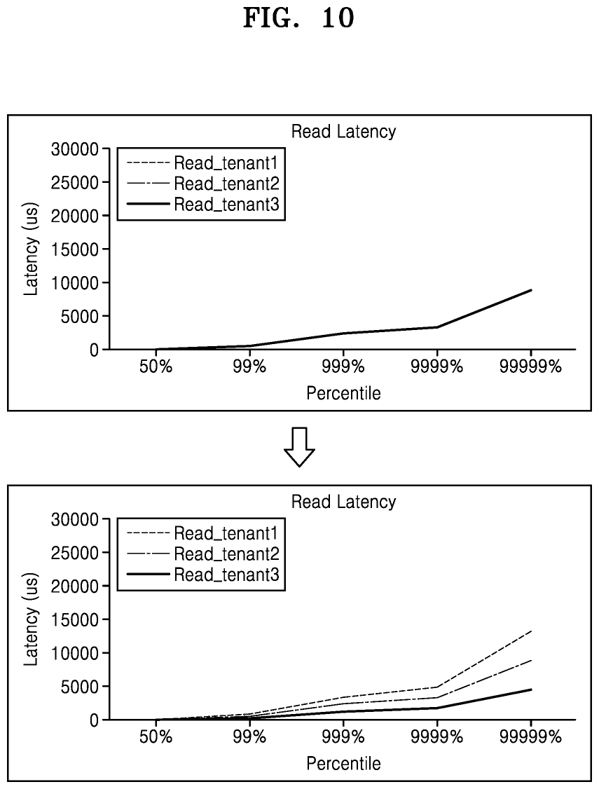

According to an embodiment, referring to FIG. 10, a percentile-latency graph of a read command is shown. It can be seen that percentile-based latencies of a write command of all latencies according to the comparative example (top graph) are equal to one another. In other words, because the storage device according to the comparative example does not provide the host device with duration information and an allocation ratio-based latency of a resource for processing an internal event and the host device does not select a resource allocation ratio, latencies of all tenants may be equal to one another.

A first tenant according to an embodiment may be a host device which has selected the first operation mode, a second tenant may be a host device which has selected the second operation mode, and a third tenant may be a host device which has selected the third operation mode. As described above, it can be seen that a tail latency of a read command recognized by the first tenant increases rapidly as a percentile increases. Because a storage device of the first tenant allocates all resources to an operation of performing the internal event in the first operation mode and does not allocate a resource for performing the read command, the tail latency of the read command recognized by the first tenant may rapidly increase. It can be seen that a tail latency of a read command recognized by the third tenant increases in proportion to a percentile, but the size of a latency is reduced compared to the other tenants. Because a storage device of the third tenant allocates minimum resources to an operation of performing the internal event in the third operation mode and allocates most of all resources to processing of a write command requested by the host device, a tail latency of the read command recognized by the third tenant may be improved compared to the other tenants.

While the inventive concept has been particularly shown and described with reference to embodiments thereof, it will be understood that various changes in form and detail may be made thereto without departing from the spirit and scope of the inventive concept as set forth in the following claims.

What is claimed is:

1. A storage controller comprising:
an internal event monitoring circuit configured to detect that an internal event occurs, wherein the internal event is independently performed in the storage controller;
a duration calculation circuit configured to calculate expected processing times of the internal event based on each of a plurality of allocation ratios;
a latency mapping table configured to output expected latencies in processing the internal event for each of the plurality of allocation ratios; and
an update circuit configured to generate multi-latency information and provide the multi-latency information to a host device, wherein
the multi-latency information includes an indicator representing the internal event and the expected processing times and the expected latencies respectively corresponding to the plurality of allocation ratios,
each of the plurality of allocation ratios represents a ratio of a resource, allocated to process the internal event, to a resource allocated to process a command requested by the host device, and
the storage controller is configured to allocate resources for processing the command and the internal event, based on an allocation ratio selected by the host device from among the plurality of allocation ratios.

2. The storage controller of claim 1, wherein the internal event comprises a read reclaim, a wear leveling, a garbage collection, a bad block detection, or a block close.

3. The storage controller of claim 1, wherein the plurality of allocation ratios comprise:
a first ratio where resources of the storage controller are allocated to performing the internal event;
a second ratio where half of the resources of the storage controller are allocated to performing the internal event and the other half of the resources of the storage controller are allocated to performing a command received from the outside; and
a third ratio where a minimum-sized resource of the resources of the storage controller is allocated to performing the internal event and the other resources, except the minimum-sized resource, of the resources of the storage controller are allocated to performing the command received from the outside.

4. The storage controller of claim 1, wherein the duration calculation circuit is configured to obtain an expected processing time corresponding to the internal event, based on an internal write speed and a size of internal write data, needed to perform the internal event received from the internal event monitoring circuit, and one of the plurality of allocation ratios.

5. The storage controller of claim 3, wherein first multi-latency information generated based on the first ratio comprises a first latency and a first duration,
second multi-latency information generated based on the second ratio comprises a second latency, which differs from the first latency, and a second duration, which differs from the first duration, and
third multi-latency information generated based on the third ratio comprises a third latency, which differs from the first latency and the second latency, and a third duration, which differs from the first duration and the second duration.

6. The storage controller of claim 5, wherein the first latency is greater than the second latency, and the second latency is greater than the third latency, and
the first duration is less than the second duration, and the second duration is less than the third duration.

7. An operating method of a storage controller, the operating method comprising:
detecting an internal event that is capable of being independently performed in the storage controller;
calculating expected processing times of the internal event based on each of a plurality of allocation ratios, wherein each of the plurality of allocation ratios represents a ratio of a resource, allocated to process the internal event, to a resource allocated to process a command requested by a host device;
calculating expected latencies in processing the internal event based on each of the plurality of allocation ratios;
generating multi-latency information respectively corresponding to the plurality of allocation ratios, wherein the multi-latency information includes an indicator representing the internal event and the expected processing times and the expected latencies;
providing the multi-latency information to the host device; and
receiving a response indicating an allocation ratio, selected by the host device from among the plurality of allocation ratios, from the host device to allocate resources for processing the internal event and the command requested by the host device.

8. The operating method of claim 7, wherein the internal event comprises a read reclaim, a wear leveling, a garbage collection, a bad block detection, or a block close.

9. The operating method of claim 7, wherein the plurality of allocation ratios comprise:
a first ratio where resources of the storage controller are allocated to an operation of performing the internal event;
a second ratio where half of the resources of the storage controller are allocated to the operation of performing the internal event and the other half of the resources of the storage controller are allocated to an operation of performing a command received from the outside; and
a third ratio where a minimum-sized resource of the resources of the storage controller is allocated to the operation of performing the internal event and the other resources, except the minimum-sized resource, of the resources of the storage controller are allocated to the operation of performing the command received from the outside.

10. The operating method of claim 9, wherein first multi-latency information generated based on the first ratio comprises a first latency and a first duration,
second multi-latency information generated based on the second ratio comprises a second latency, which differs from the first latency, and a second duration, which differs from the first duration, and
third multi-latency information generated based on the third ratio comprises a third latency, which differs from the first latency and the second latency, and a third duration, which differs from the first duration and the second duration,
the first latency is greater than the second latency, and the second latency is greater than the third latency, and
the first duration is less than the second duration, and the second duration is less than the third duration.

11. A storage system comprising:
a storage device including an internal event monitoring circuit configured to detect an occurrence of an internal event that is independently performed in a storage controller, a duration calculation circuit configured to calculate expected processing times of the internal event based on each of a plurality of allocation ratios representing a ratio of a resource, allocated to process the internal event, to a resource allocated to process a command requested by a host device, and an update circuit configured to generate multi-latency information, and provide the multi-latency information to the host device, wherein the multi-latency information includes an indicator representing the internal event and the expected processing times and the expected latencies respectively corresponding to the plurality of allocation ratios; and
the host device configured to select an allocation ratio from among the plurality of allocation ratios and provide the storage device with mode information indicating the selected allocation ratio, wherein
the storage device is configured to receive the mode information from the host device and allocate each of resources for processing the internal event and the command requested by the host device, based on the allocation ratio indicated by the mode information.

12. The storage system of claim 11, wherein the plurality of allocation ratios comprise:
a first ratio where resources of the storage controller are allocated to performing the internal event;
a second ratio where half of the resources of the storage controller are allocated to performing the internal event and the other half of the resources of the storage controller are allocated to performing a command received from the host device; and
a third ratio where a minimum-sized resource of the resources of the storage controller is allocated to performing the internal event and the other resources, except the minimum-sized resource, of the resources of the storage controller are allocated to performing the command received from the host device.

13. The storage system of claim 12, wherein first multi-latency information generated based on the first ratio comprises a first latency and a first duration,
second multi-latency information generated based on the second ratio comprises a second latency, which differs from the first latency, and a second duration, which differs from the first duration, and
third multi-latency information generated based on the third ratio comprises a third latency, which differs from the first latency and the second latency, and a third duration, which differs from the first duration and the second duration.

14. The storage system of claim 13, wherein the first latency is greater than the second latency, and the second latency is greater than the third latency, and
the first duration is less than the second duration, and the second duration is less than the third duration.

15. The storage system of claim 12, wherein the host device is configured to select an allocation ratio for indicating resource allocation of the storage device from among the plurality of allocation ratios, based on a length of a command queue, a depth of the command queue, a quality of service (QOS) value, and a size of an input/output bandwidth corresponding to the storage device.

16. The storage system of claim 15, wherein the host device is configured to provide the storage device with mode information indicating the third ratio when the QoS value is greater than a first threshold value,
provide the storage device with mode information indicating the first ratio when the QoS value is less than a second threshold value, which is less than the first threshold value, and
provide the storage device with mode information indicating the second ratio when the QoS value is less than the first threshold value and greater than the second threshold value.

17. The storage system of claim 15, wherein the host device is configured to provide the storage device with mode information indicating the first ratio when the length of the command queue is less than a first threshold length.

18. The storage system of claim 17, wherein the host device is configured to provide the storage device with mode information indicating the third ratio when the length of the command queue is less than a second threshold length, and
the second threshold length is greater than the first threshold length.

19. The storage system of claim 11, wherein the duration calculation circuit is configured to obtain an expected processing time corresponding to the internal event, based on an internal write speed and a size of internal write data, needed to perform the internal event received from the internal event monitoring circuit, and one of the plurality of allocation ratios.

20. The storage system of claim 11, wherein the internal event comprises a read reclaim, a wear leveling, a garbage collection, a bad block detection, or a block close.
